(19) United States
(12) Patent Application Publication
(10) Pub. No.: US 2013/0177789 A1
(43) Pub. Date: Jul. 11, 2013

(54) REDOX FLOW BATTERY SYSTEM EMPLOYING DIFFERENT CHARGE AND DISCHARGE CELLS

(71) Applicants: Krisada Kampanatsanyakorn, Bangkok (TH); Suradit Holasut, Chiangmai (TH)

(72) Inventors: Krisada Kampanatsanyakorn, Bangkok (TH); Suradit Holasut, Chiangmai (TH)

(73) Assignee: SQUIRREL HOLDINGS LTD, George town, Grand Cayman (KY)

(21) Appl. No.: 13/816,811

(22) PCT Filed: Aug. 13, 2010
(86) PCT No.: PCT/IB10/02004

§ 371 Date: Mar. 28, 2013

(51) Int. Cl. H01M 2/40; H01M 8/20

(52) U.S. Cl. CPC H01M 2/40; H01M 8/20
USPC 429/70

(57) ABSTRACT

Enhanced storage efficiency, reliability and durability of a redox flow battery system are achieved by employing distinct pluralities or groups of cells wherein all the cells of a first plurality have porous metallic electrodes in both compartments through which respective electrolyte solutions flow during a charging process of the battery system, and all cells of a second plurality may have porous carbon felt electrodes in both flow compartments through which the respective electrolyte solutions flow during a discharging process of the battery systems or solely in the compartment through which the negatively charged electrolyte solution flows and a porous metallic electrode in the other compartment where the positively charged electrolyte solution flows. All the cells of both groups of cells may be defined by repetitive sequences of stackable elements, according to a common bipolar or monopolar cell stack architecture.

### TECHNICAL FIELD

The present disclosure relates generally to redox flow battery systems employing multicell stack reactors.

### BACKGROUND

The so-called redox flow battery systems or briefly redox batteries, store energy in acid electrolyte solutions, namely a positive and a negative solution, that are flown through respective electrode compartments of the cells of a multicell electrochemical reactor during charge and discharge phases. The unlimited possibility of storing large volumes of positively and negatively charged electrolyte solutions containing ions of the so-called redox couple, make these systems exceptionally suitable for load-leveling (peak-shaving) in electric power generation and distribution industry, as storage battery in self standing wind farms or solar photovoltaic conversion plants as well as for powering vehicles. Most redox flow battery systems employ a multi-cell bipolar stack.

The redox couples used in a flow redox battery system are typically of multivalence metals dissolved in the two respective positive and negative electrolyte solutions, typically an acid electrolyte capable of dissolving the multivalence metal or metals in all states of oxidation. The above considerations are generally applicable to any multivalent metal providing a viable redox couple dissolved in an aqueous acid solution, wherein the redox couple metal ions sustain the anodic oxidation reaction and the cathodic reduction reaction the product of which remains dissolved in the acid electrolyte solution without undergoing any phase change, both during an electrochemical charging process as well as during an electrochemical discharge process. Vanadium, iron, chromium are the most commonly used metals to constitute usable redox couples in the positively charge electrolyte solution and in the negatively charged electrolyte solution.

Because of the many advantages recognized to a so called “all-vanadium” redox flow battery system, versus other known redox flow systems using redox couples of distinct metals in the positively charged and in the negatively charged electrolyte solutions, respectively, the ensuing description of exemplary embodiments will privileged reference to an all vanadium redox system. It should be clear that the considerations and advantages of the electrochemical plant architecture of the present disclosure remain applicable, mutatis mutandis to the use of other redox couples even of different metals.

A distinctive feature of flow redox battery systems is the, at least ideally, absence of gaseous substance evolution at the cell electrodes, during discharging as well as during charging processes.

However, as will be explained in this disclosure, unwanted hydrogen evolution may take place at certain conditions of operation of the cells, in view of the fact that cathodic hydrogen evolution is the favorite reaction in an acid environment and in order to contrast this thermodynamically favorite reaction at a cathodically polarized electrode, graphite or carbon electrodes are often used in redox flow cells because of the relative high hydrogen discharge over-voltage of carbon-base materials (often electrically conductive aggregates of carbon particles with a resin binder).

In order to enhance performance of relatively poorly conductive and poorly catalytic carbon electrode surfaces, the electrodes or more particularly the active electrode surface thereof is generally in form of a porous felt of carbon fibers readily permeated by the flowing electrolyte solution and back-contacted by the generally planar surface of a carbon-base bipolar electrical interconnecting septum (briefly “interconnect”) defining the respective flow compartment in cooperation with the opposing permionic membrane cell separator.

Carbon-base conductive plates pose fabrication limits to the maximum extension plate articles of graphite, glassy carbon or of aggregate of carbon particles and/or fibers may be economically fabricated and used in a form that must ensure acceptable mechanical sturdiness.

Another typical feature of redox flow cells is that the electrodes alternately switch back and forth from a cathodic polarization to an anodic polarization versus the respective electrolyte solution during discharging and charging phases of operation. This has practically excluded the possibility of using metal-base electrodes in the cells, because of their inability to withstand or perform in both conditions of polarization and has promoted the use of identical carbon-base electrodes in the respective flow compartments of the cells notwithstanding the many drawbacks that such an obliged choice entails.

For example, with a positively charged sulfuric acid electrolyte solution contaning the redox couple V[V]/V[IV], the positive electrode of the battery behaves as anode during a charging cycle extracting electrons from V[IV] in oxidizing vanadium to V[V] according to the reaction:

2VO²⁺+H₂O=2VO₂⁺+2H⁺+e₋ E⁰_{Ox}=1.00 Volt (1)

However, this is not the only reaction that may occur; a competitive reaction is the oxidation of water with the evolution of oxygen:

H₂O=½O₂+2H⁺+2e⁻ E⁰_{Ox}=1.23 Volt (2)

The reason why the reaction (1) is the predominant reaction during charging is because the standard potential of reaction (1) is only 1 Volt while the standard potential of reaction (2) is higher and equal to 1.23 Volt. But these potentials are only the standard potentials, i.e. the voltage at which the reactions occur in standard conditions (25° C., at 1 Mole/liter, etc.). However, when the concentration of the reacting species decreases, the voltage will increase logarithmically according to the Nernst equation. Therefore, when during a charging cycle the concentration of the vanadile ions decreases, the corresponding voltage of the anodic reaction (1) will increase. At a high state of charge the split of the charging current between the two competitive anodic reactions will not longer favor the reaction (1) (i.e the desired V[IV] oxidation) but part of the electric current will support the parasite reaction (2). At very high state of charge, when almost all or all the V[IV]is oxidized to V[V], the only reaction that can and will occur will be the evolution of oxygen.

An attendant risk is that, when carbon or graphite electrode and/or distribution plates based on graphite are used, the oxygen evolved easily oxidizes the carbon degrading the felt electrode and even the current distributing back plate or intercell interconnect, through the following reaction:

2H₂O+C═CO₂+4H⁺+4e⁻ (3)

In order to assure a long life of the positive electrode (felt and plates) based on carbon or graphite it is necessary to arrest the charging process upon reaching about 85%-to-90% of the maximum state of charge that maybe assumed by the positively charged electrolyte solution.

The use of carbon-base electrodes does not allow in practice a full charging of the positive electrolyte solution in consideration of the weakness of carbon based electrodes when anodically polarized versus the respective positive electrolyte solution when recharging the battery system. As oxidation of the multivalent ions in the positive electrolyte solution of the battery systems approaches the fully oxidized condition (100% charge), evolution of oxygen at the anode surface starts to be competitive toward the oxidation of the multivalent ions because of a reduced mass transfer across the electrode surface double layer (significant depletion). Moreover as discussed above, in these conditions, oxygen discharge may be practically “depolarized” by carbon through a combustion process with the nascent oxygen, which may rapidly destroy the carbon based electrode (often a carbon fiber felt) and may even degrade a carbon-base conductive intercell interconnect or current distributing/collecting back wall of the flow compartment of the cell.

Redox flow battery systems have an energy storage capacity strictly tied to the volumes of the two distinct positive and negative electrolyte solutions. This would ideally require the ability to fully charge the electrolyte solutions for maximizing energy storage per volumes of electrolyte solutions.

On another account, with a negatively charged sulfuric acid electrolyte solution contaning the redox couple V[III]N[IV], the negative electrode of the battery behaves as cathode during a charging cycle ceasing electrons to V[IV] reducing it to V[III]. Under certain conditions of operation parasitic hydrogen evolution may not be avoided at the negative electrode (cathode) of the cell. In particular, hydrogen evolution cannot be avoided when first conditioning a completely homogeneous system (first conditioning of the two electrolyte solutions). In fact, at start-up, the positive and negative tanks are filled with the same solution: practically containing 50% V[III] and 50% [IV]. The two solutions are then circulated through the corresponding compartments of the cells and an electric current forced through the cells disrupts the chemical homogeneity of the solutions oxidixing all the V[III] to V[IV] in the solution flown through the positive electrode compartment and reducing all the V(IV) to V[III] in the solution flown through the negative electrode compartment. At the negative electrode (cathode) the reaction being:

V0²⁺+e⁻+2H⁺=V³⁺+H₂O (4)

At the end of the conditioning period the negative electrolyte solution will contain only trivalent vanadium while the positive electrolyte solution will contains only tetravalent vanadium (vanadile).

During the conditioning process, hydrogen is evolved at the negative electrode as reported in¹. ¹“Investigation of Hydrogen Evolution during the Preparation of Anolyte for a Vanadium Redox Flow Battery”, by X. Gao, M. J. Leahy and D. N. Buckley.

Of course, evolution of hydrogen according to: 2H⁺+e⁻=H₂O is the only reaction that will occur when, at the end of a charging cycle of the functioning redox flow battery system, all the trivalent vanadium has been converted to bivalent vanadium.

Moreover, notwithstanding the use of carbon electrodes of relatively large hydrogen over-voltage for effectively under privileging cathodic hydrogen evolution that remains a thermodynamically privileged cathodic reaction in acid electrolytes, even during charging processes parasitic hydrogen evolution may also occurs, though at a very minoritary rate for various accidental reasons such as:

uneven distribution of electrolyte to the active electrode (cathode) surface causing local depletion of reagent species (trivalent vanadium);

excessively high current density at “hot spots” caused by uneven current distribution over the projected area of the electrode (cathode when charging);

presence of traces of metals having a low hydrogen overvoltage, such as Fe, Ni, Co, etc in the electrolyte. These metal deposit onto the negative electrode surface (cathode when charging) and catalyze hydrogen evolution.

When hydrogen is evolved, it must be released at the outlet of the respective compartment of each cell, to minimize disruption of uniformity of the current density because of uneven distribution of the electrolyte solution and formation of gas locks within the porous carbon felt cathodes.

Moreover, many applications would greatly benefit from the ability of reducing the time necessary to fully charge the battery system by being able to charge the electrolyte solutions at a greater current density then the “safe” maximum current density for more reliably ensuring the rated power output capabilities of the battery systems in delivering electrical energy to electrical loads of the system.

### General Description of the Invention

These limitations and shortcomings are overcome and enhanced storage efficiency, reliability and durability of the redox flow system are achieved by employing distinct pluralities of cells wherein all the cells of a first plurality have porous metallic electrodes in both compartments through which respective electrolyte solutions flow during a charging process of the battery system and all cells of a second plurality may have porous carbon felt electrodes in both flow compartments through which the respective electrolyte solutions flow during a discharging process of the battery systems or solely in the compartment through which the negatively charged electrolyte solution flows and a porous metallic electrode in the other compartment where the positively charged electrolyte solution flows.

All the cells of the second plurality, destined to function during discharge of the flow redox energy storage system to power electrical loads, may have a common structure with carbon felt electrodes in both compartments and a intercell interconnect or electrode current distributor plate to the carbon felt electrodes made of a conductive aggregate of carbon particles or fibers and of a resin binder in both flow compartments of the cell.

Alternatively and preferably, an all carbon-based facing and an active porous carbon electrode may be retained only in the flow compartment of the “positively charged” electrolyte solution, at the surface of which ions of the redox couple in the flowing electrolyte solution undergo cathodic reduction, and a titanium base dimensionally stable anode of enhanced oxidizing activity of ions of the redox couple in the “negatively charged” electrolyte solution and at the surface of which ions of the redox couple in the flowing electrolyte solution undergo anodic oxidation.

Even more preferably, the permionic membranes used in all the cells of the second plurality (discharge cells), may have, over the surface in contact with the positively charged electrolyte solution (i.e. toward the substantially “all-metallic” flow compartment of the cell) a porous electro-catalytic facing layer of particles of an acid resistant and anodically stable metal black, typically a platinum black, bonded to the permionic membrane by hot pressing the highly catalytic particles mixed with a particulated non filming resin binder such as a polytetrafluoroethylene. According to this embodiment, the adhered porous layer constitutes an anode of much augmented specific active area capable of performing at a proportionately increased current density without excessive parasitic oxygen discharge and the pack of activated titanium micro-meshes will in practice function as current distributor to the active metal black particles layer bonded to the permionic membrane.

In any case, the intercell interconnect or electrode current distributor plate may have a titanium sheet facing in contact with the flowing “negatively charged” electrolyte solution for enhancing electrical conductivity through or along the electrically conductive septum and equipontentiality over the whole active projected area of the cell.

Differently, all the cells of the first plurality, destined to function for charging the redox flow battery system have metallic electrodes, for example of titanium, tantalum, zirconium (eventually coated with a layer containing a noble metal or a noble metal oxide, sub-oxides or mixed oxides), stainless steel, Hastelloys, titanium-palladium, titanium-nickel, lead, lead containing alloys, antimony, antimony containing alloys, all resistant to acid aqueous electrolyte solutions. The electrode in one flow compartment of the cells may include a n anodically passivating subtrate metal such as for example titanium, tantalum and alloys thereof, coated with an active surface layer that may contain, for example, ruthenium or iridium oxides mixed with titanium or tantalum oxides, over the surface of which the ions of the redox couple contained in the “spent” positively charged electrolyte solution undergo anodic oxidation, while the porous electrode in the other flow compartment of the cells may be of a metal or metal alloy having a relatively high hydrogen ion discharge overvoltage such as for example lead, antimony, lead-antimony alloys, stainless steel, titanium-palladium and titanium-nickel alloys, Hastelloys, optionally coated with a surface layer of lead and/or antimony, over the surface of which the ions of the redox couple contained in the “spent” negatively charged electrolyte solution undergo cathodic reduction.

Of course, the metallic electrodes must be resistant to the acidic electrolyte solutions, at the “free-acid” concentrations at which the redox system operates. In the case of an all-vanadium storage battery system, the metallic structural elements in contact with the electrolyte solutions must resist attack from the sulfuric acid solutions of vanadium.

Metallic electrodes have the advantage of alleviating the problem of efficient electronic current distribution or collection from the active surface sites of ion charge and ion discharge commonly posed by carbon felt electrodes. Metallic electrodes, even when compressively held in contact with a conductive back wall of the flow compartment or a conductive intercell interconnect ensure a far better electrical contact and may even be spot welded to it for minimizing contact resistances. Moreover, they have a much greater lateral conduction resistance (current paths in the electrode surface plane opposite to the counter electrode of the cell on the other side of the permionic membrane cell separator) than a carbon felt. Electrical cell resistance is thus significantly reduced and an enhanced equipotentiality over the whole active cell area is achieved, which also lessens risks of “hot spot” phenomena where locally the current density may inadvertently surpass design limit levels.

The metal electrodes should provide an active surface in contact by the electrolyte solution streaming through the typically shallow flow compartment without causing an excessive pressure drop in order not to burden power absorption by indispensable circulation pumps. Single or multiple micro wire nets or expanded thin metal sheets, eventually activated by an electro-catalytic coating as in the case of electrodes that are subject to function as anodes, having a base of an acid resistant metal and eventually also anodically passivable such as titanium, tantalum, and alloys thereof, stainless steel, Hastelloys, optionally undulated or deep-drawn at evenly distributed points or along uniformly spaced parallel lines in order to form spaced point rests pressing against the surface of the intercell interconnect, upon tightening the stack assembly, may be used in the cell compartments in lieu of a common compressible carbon felt electrode.

Alternatively, the multiple or single wire net or expanded thin metal sheet may be spot welded onto the surface of the intercell interconnect. Of course, instead of plastically deforming the micro wire nets or expanded thin metal sheets, the conductive back wall or intercell interconnect may have spaced ribs or evenly distributed protrusions of same height over the central active cell area thereof on the crests or tips of which, the active electrodes of micro wire net or expanded thin metal sheet may be pressed in contact or be spot welded.

The substantially all-metallic cells (charge cells) of the first plurality may have a projected active cell area (i.e. the projected area of the metallic electrodes and of the permionic membrane separator of the two flow compartments of the cell) smaller than the projected active cell area of the cells of the second plurality (discharge cells), to reduce costs of construction materials (electrodes and permionic membranes inventories) because of the elimination of the constraints on maximum affordable ionic current density imposed by the presence of carbon based electrodes.

Alternatively or coordinately with an eventual reduction of the active cell areas, the number of cells of the first plurality (charge cells) may be different and generally less than the number of cells of the second plurality (discharge cells).

Flow rates of the electrolyte solutions through the respective flow compartments of the cells of the first plurality (charge cells) may be regulated independently from the flow rates of the electrolyte solutions through the respective flow compartments of the cells of the second plurality (discharge cells), adding adaptability to the conditions of the respective processes of charging and discharging the energy storage system.

The two processes of charging and discharging the energy storage system may be conducted simultaneously, each under independently optimizable conditions to take advantage of concurrent renewable energy sources for charging the redox flow battery system while delivering electrical power to electrical loads.

According to a preferred embodiment, the cells of both distinct pluralities are bipolar cells electrically in series and part of the same stack assembly, though distinctly connected: the first plurality to a DC electrical source and the second plurality to a DC-to-AC conversion inverter.

According to an alternative embodiment, all the cells of both distinct pluralities are monopolar cells the electrodes of which are respectively connected according to a certain series-parallel scheme: those of the first plurality to a DC electrical source and those of the second plurality to a DC-to-AC conversion inverter.

The invention and important embodiments thereof are defined in the annexed claims, the recitation of which is intended to constitute part of the present specification and is here incorporated by express reference.

### BRIEF DESCRIPTION OF THE DRAWINGS

FIG. 1 is a basic scheme of a flow redox battery system made according to the present disclosure.

FIG. 2 shows the basic scheme of FIG. 1 wherein the all metal electrode cells of a first plurality and all the cells of the second plurality are assembled in a unified stack assembly according to a preferred embodiment.

FIG. 3 replicates in part the scheme of the preceding figure schematically detailing the internal structure of stacked monopolar cells, according to a bipolar cell embodiment.

FIG. 4 reproduces in part the basic scheme of FIGS. 1 and 2 for detailing the inner cell structure according to a bipolar cell stack embodiment.

FIG. 5 is a simplified schematic exploded view of a unified stack of charge cells and discharge cells both of bipolar type.

FIG. 6 is a simplified schematic exploded view of a unified stack of charge cells and discharge cells both of monopolar type.

FIG. 7 is a “book-like” exploded view of stackable elements that define a bipolar charge cell.

FIG. 8 is a “book-like” exploded view of stackable elements that define a bipolar discharge cell.

### DESCRIPTION OF EXEMPLARY EMBODIMENTS

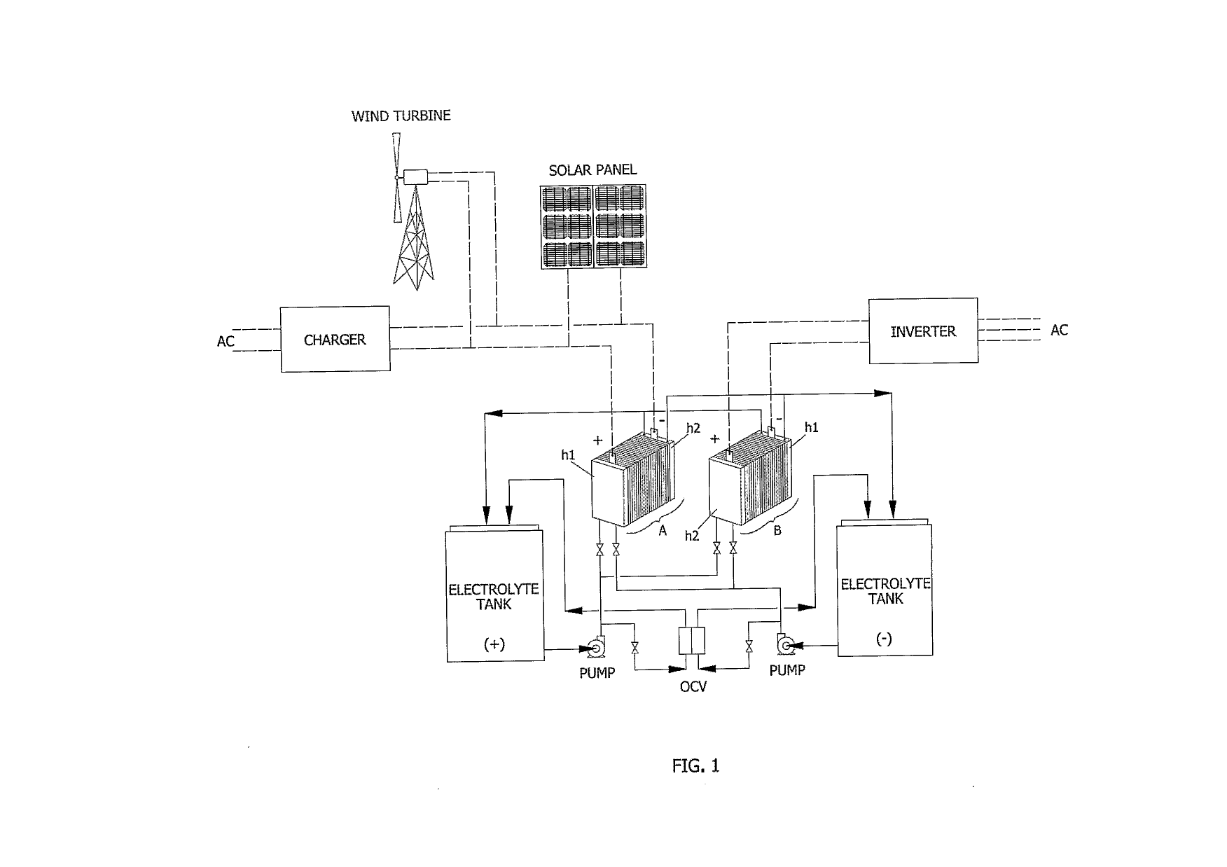

In principle, a flow redox battery system according to the present disclosure may have a functional scheme as the one depicted in FIG. 1.

As illustrated in the scheme, all the cells of a first plurality A of cells destined to charge the two electrolyte solutions of the flow redox battery system are electrically connected to one or several DC electrical sources that may be in form of a solar panel array, a wind turbine or even a battery charger.

All the cells of a second plurality B of cells destined to deliver DC electrical power to an electrical load are electrically connected to the input of a common inverter that converts DC input power to AC electrical power, typically at the frequency and rated voltage of the public distribution grid.

Differently from the electrical connection lines, the hydraulic circuits of the two distinct electrolyte solutions are traced with solid lines. The positively charged electrolyte solution is stored in the respective electrolyte tank (+) and the negatively charged electrolyte solution is stored in the respective electrolyte tank (−).

The OCV device shown in FIGS. 1 to 4 is an optional monitoring implement of the state of charge of the redox flow battery system. It may be a single scaled down cell of same structure as the cells of the group A or B. The downsized replica cell permits to monitor the open circuit cell voltage, from which is possible to know the state of charge of the electrolyte solutions. In case of an all-vanadium redox flow battery system, an open circuit cell voltage of about 1.5V indicates a state of full charge of electrolyte solutions and an open circuit cell voltage of about 1.2V indicates that the electrolyte solutions are in a fully discharged condition.

In the exemplary scheme of FIG. 1, both pluralities A and B of stacked cells, dedicated to the charging process and to the discharging process, respectively, have a bipolar stack architecture with serial flow of the two electrolyte solutions through the respective flow compartments of all the cells from one header h1 to the other header h2 of the stacked bipolar cells, whereby the two electrolyte solutions are generally fed in two distinct distribution chambers in one end header h1 and collected into similar distinct chambers of the other end header h2. Internal ducting defines the distinct serial flow paths of the two electrolyte solutions. A circulation pump is used for each electrolyte solution.

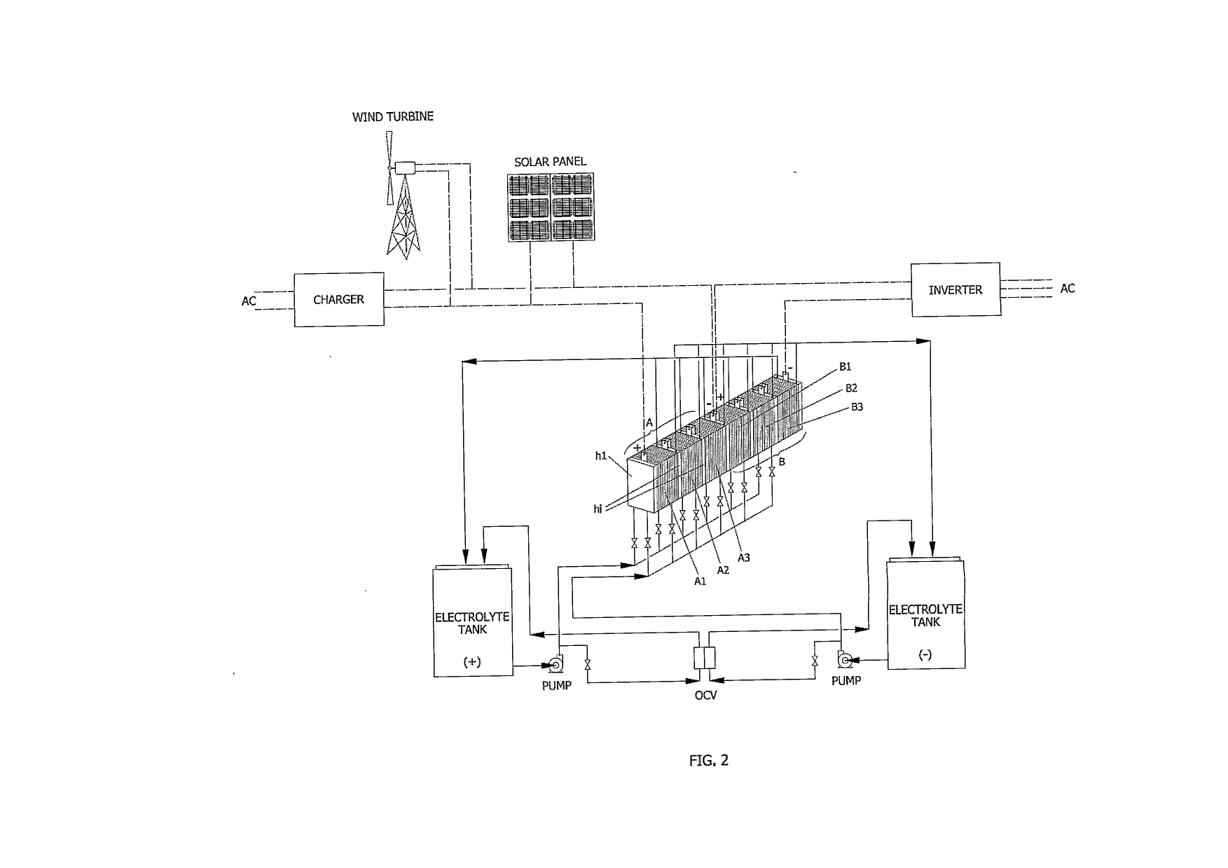

FIG. 2 depicts an alternative embodiment of the same basic scheme of FIG. 1, according to which all the cells are assembled in a unified bipolar cell stack.

In the exemplary embodiment shown, the two distinct pluralities A and B of cells destined to carry out the charging process and the discharging process of the battery system, respectively, the electrical end terminals of which are identified by the respective electrical connections to the possible types of DC power sources and to the input of a conversion inverter, are composed by three stacked sub-groups of serial flow bipolar cells A1, A2 and A3.

Intermediate headers hᵢ have four distinct electrolyte chambers providing for the exit of the two solutions flown serially through a sub-group of bipolar cells and for feeding the electrolyte solutions to the respective compartments of a first or inlet cell of the successive stacked sub-group of cells and so forth.

Subdivision of the plurality of cells destined to charge the flow redox battery system and of the second plurality of cells destined to deliver DC power towards the electrical loads, into sub-groups of cells (three sub-groups of cells in the depicted example), accomplishes the aim of incrementing the acceptable DC voltage generated by the particular DC electrical source that is exploited for charging the flow redox battery system and the DC voltage produced at the input of the DC-AC conversion inverter. At the same time, these increased DC input and output voltage capabilities of the multicell battery are made compliant with the attendant requirement of limiting the pressure drop (pumping losses) in flowing the two electrolyte solutions serially through tortuous inner ducting from a compartment of a cell to the correspondent compartment of the next cell. The parallel distribution of the circulating electrolyte solutions through a number of intermediate headers permits to limit the increment of overall pressure drop when augmenting the number of cells to function in serial (cascade) flow mode.

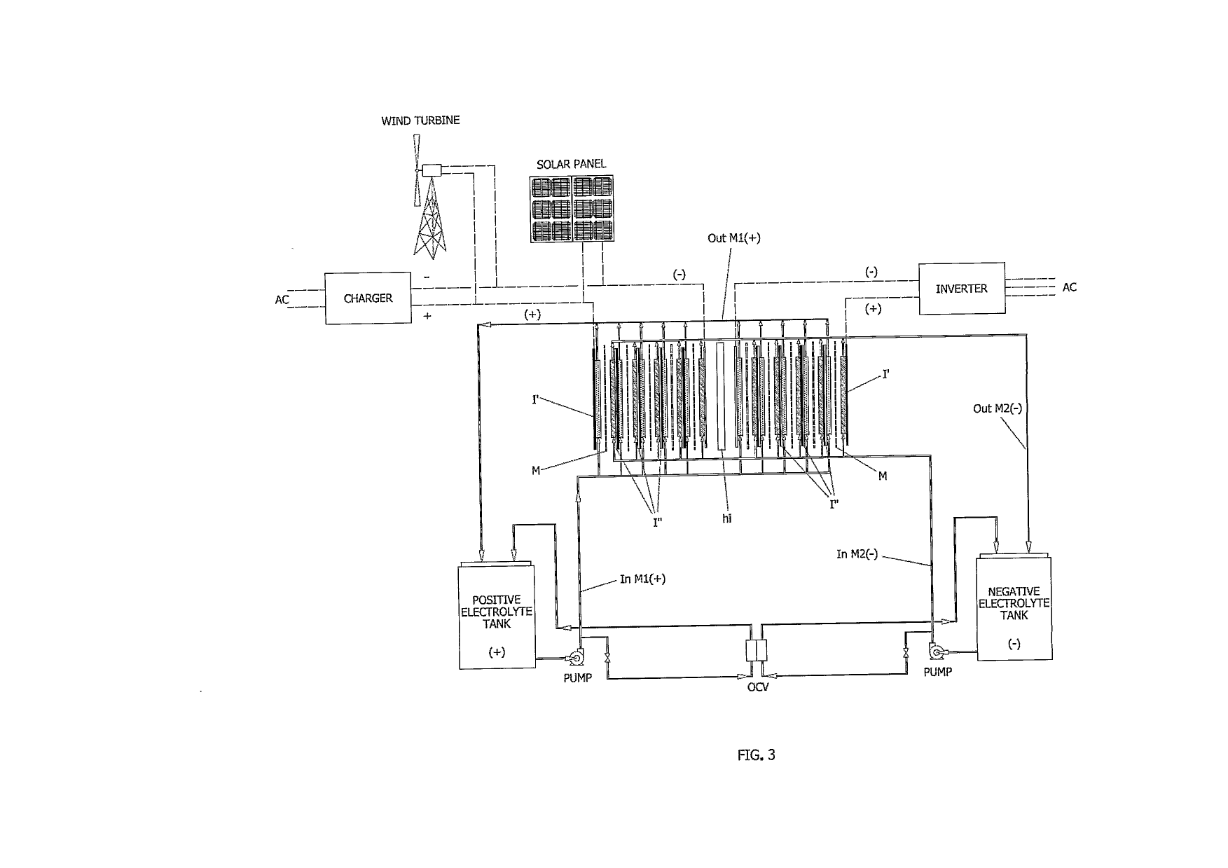

FIG. 3 replicates in part the basic scheme of FIGS. 1 and 2 for detailing the inner cell structure for a bipolar cell stack arrangement of the cells.

The basic inner cell structure is schematically depicted for only two groups of stacked bipolar cells, the group of cells on the left end side being used for charging the two electrolyte solutions by forcing a DC current through the sequence of bipolar cells of the group, exploiting the available DC voltage source.

The group of stacked bipolar cells on the right end side is used to deliver DC power to AC electrical loads through an inverter, by discharging the two electrolyte solutions.

The porous electrodes drawn with a light-dot hatching are preferably made of micro nets of an acid solution resistant and anodically stable base metal, like titanium or tantalum, activated by an electro-catalytic surface coating containing a noble metal or a noble metal oxide or mixed oxide. The porous electrodes drawn with dense line-hatching are also preferably metallic, of a metal or metal alloy having a relatively high hydrogen overvoltage, like lead or more preferably a lead-molybendum alloy in form of micro nets or wire mats. Alternatively, at least in the cells belonging to the group of cells that supply a DC voltage to the input of the inverter (discharge cells), the electrodes drawn with dense line-hatching may be of porous carbon felt.

The intercell interconnects I″ of both groups of bipolar stacked cells may be an electrically conductive aggregate of carbon and/or graphite particles and/or fibers with a resin binder or, more preferably, are made of a laminated sheet including at least a thin sheet of an acid resistant metal or metal alloy adapted to establish a good electrical contact with the porous electrodes, drawn with a light dot-hatching, of activated metallic micro nets or spot welded to them, and of a second thin sheet of a different metal or coating of acid resistant metal, having a suitably high hydrogen overvoltage, like for example a sheet or coating layer of lead, or of a lead-antimony alloy, adapted to establish a good electrical contact with the porous electrodes of relatively high hydrogen overvoltage, made for example of micro nets or wire mats of lead or lead-antimony alloys or of porous carbon felts or mats, drawn with a dense line-hatching.

The terminal current distributing septa I will have a surface in contact with the end electrodes of the groups of bipolar stacked cells, of appropriate electro-chemical characteristics and their structure is adapted to ensure a satisfactory equipotentiality and adapted to be electrically connected to the positive (+) and negative (−) rails of the respective DC buses for charging and discharging the redox flow battery system.

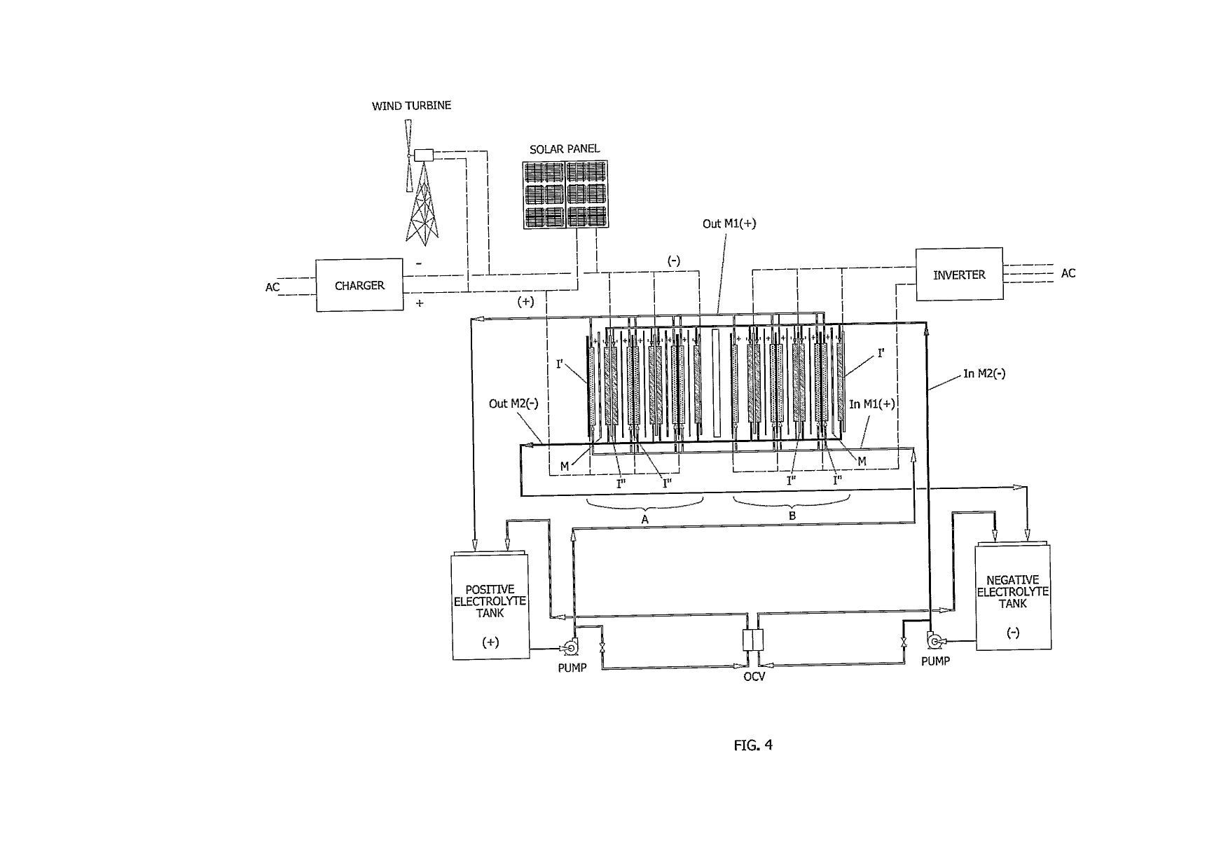

FIG. 4 replicates in part the basic scheme of FIGS. 1 and 2 for detailing the inner cell structure for a monopolar cell stack arrangement of the cells.

The basic inner cell structure is schematically depicted for only two groups of stacked cells, the group of cells on the left end side being used for charging the two electrolyte solutions by forcing a DC current through the sequence of bipolar cells of the group, exploiting the available DC voltage source.

The group of stacked monopolar cells on the right end side is used to deliver DC power to AC electrical loads through an inverter, by discharging the two electrolyte solutions.

The porous electrodes drawn with a light-dot hatching are preferably made of micro nets of an acid solution resistant and anodically stable base metal, like titanium or tantalum, activated by an electro-catalytic surface coating containing a noble metal or a noble metal oxide or mixed oxide. The porous electrodes drawn with dense line-hatching are also preferably metallic, of a metal or metal alloy having a relatively high hydrogen overvoltage, like lead or more preferably a lead-molybdenum alloy in form of micro nets or wire mats. Alternatively, at least in the cells belonging to the group of cells that supply a DC voltage to the input of the inverter (discharge cells), the electrodes drawn with dense line-hatching may be of porous carbon felt

The intercell interconnects I″ of both groups of monopolar stacked cells may all be of an electrically conductive aggregate of carbon and/or graphite particles and/or fibers with a resin binder or, more preferably, and differently from the case of the bipolar cell stack of FIG. 3, may be of two different compositions, alternately assembled in the sequence of stacked monopolar cells.

The intercell interconnects I″ of both groups of monopolar stacked cells contacting the porous electrodes drawn with a light dot-hatching or spot welded to them, of activated metallic micro nets, over both sides, may be made with a sheet of an acid resistant metal or metal alloy adapted to establish a good electrical contact with the same type of electrodes (i.e. exposed to the same electrochemical agents and working conditions).

The intercell interconnects I″ of both groups of monopolar stacked. cells contacting the porous electrodes of relatively high hydrogen overvoltage (micro-nets or wire-mats of lead or lead-antimony alloys or porous carbon felts), drawn with dense line-hatching, may be made with a sheet of an acid resistant metal or metal alloy adapted to establish a good electrical contact with the same type of electrodes over both sides and having a suitably high hydrogen overvoltage, like for example a sheet of stainless steel or hastelloy, optionally coated with a layer of lead or of a lead-antimony alloy.

In case of monopolar cell stacks, the intercell interconnects I″ do not need to be septa of hydraulic separation and optionally they may have an open structure in a central area, coinciding with the projected area of the porous electrodes. For example, they may have a central area in form of an expanded sheet or with uniformly distributed close-spaced apertures or through holes, and a perimeter, essentially solid, seal surface. The open structure of intercell interconnects I″ will ensure equalization of hydraulic pressure in the same flow compartments of adjacently stacked cells, should it be desirable to relax manifolding design constraints.

The terminal current distributing septa I′ will have a surface in contact with the end electrodes of the groups of bipolar stacked cells, of appropriate electro-chemical characteristics (as the corresponding intercell interconnects) and their structure may be such to ensure a satisfactory equipotentiality and adapted to be electrically connected to the positive (+) and negative (−) rails of the respective DC buses for charging and discharging the redox flow battery system.

In the partial illustrations FIG. 3 and FIG. 4 of the repetitive arrangements of stacked elements constituting a sequence of bipolar and monopolar cells, respectively, can be clearly though schematically observed the flow compartments through which are flown the two electrolyte solutions, fed through respective inlet and outlet manifolds: inM1(+), outM1(+), inM2(−), outM2(−), in parallel to all the respective cell compartments, and the electrical connections of the conductive current distributing end interconnects I′ of stacked bipolar cells or alternately of all intercell interconnects I′ and I″ of stacked monopolar cells, to the positive (+) and negative (−) DC rails.

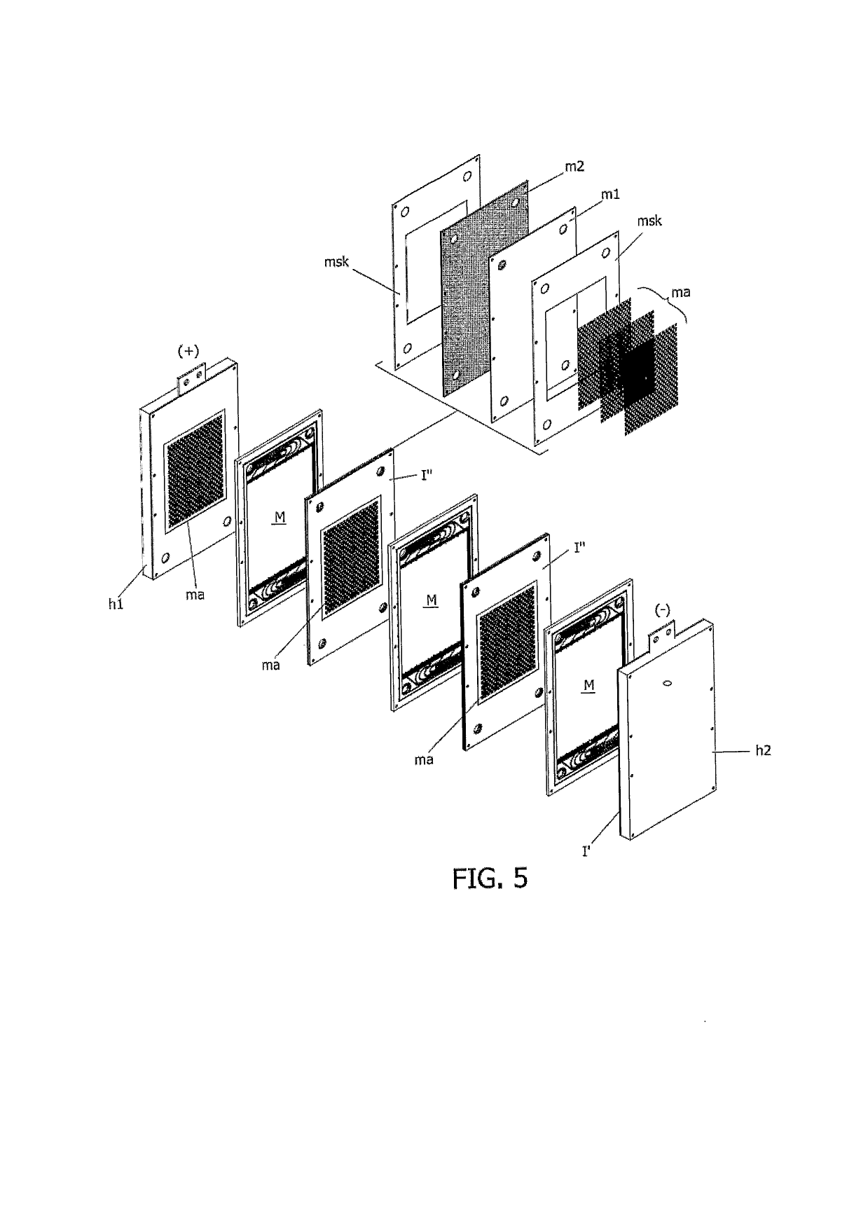

FIG. 5 is an exploded tridimensional view of a bipolar cell stack assembly for detailing an exemplary constitution of all metallic bipolar cell interconnects I″ and porous metallic base electrodes destined to be anodically polarized in the electrolyte solution flowing in contact therewith.

The laminated structure of the bipolar intercell interconnects I″, according to an all metallic embodiment of a stacked group of cells intended to function for charging or for discharging the redox battery system, is depicted in the exploded detail view of one bipolar intercell interconnect.

The depicted bipolar cell stack is a three-cell assembly, each cell including essentially a permionic membrane assembly M similar to the assembly of FIG. 3 of the cited prior PCT patent application similar to an embodiment described in the above cited prior PCT patent application No. PCT/IB2010/001651, of the same applicant. Each membrane assembly M is sandwiched between bipolar intercell interconnects I″ or equivalent terminal interconnects I′ at the end headers h1 and h2. The signs of electrical connection terminals of the end interconnects I′ indicated in the figure are coherent to the connection of the bipolar cell stack to a DC voltage source for charging the electrolyte solutions of the redox flow battery system. However, a similar stacked group of bipolar cells may be used for charging the redox flow battery system, the signs of connection of the end interconnects of the stack would in this case be inverted.

As shown in the exploded view of one of the bipolar intercell interconnects I″, the core of the electrically conductive septum, according to a preferred embodiment, may be composed by two sheets of different metals m1 and m2 bonded together in electrical contact with each other. The sheet m1 destined to be anodically polarized in the electrolyte solution flowing through the respective cell compartment may be of an anodically passivating, acid resistant metal; for example: titanium, tantalum or alloys thereof. The metal sheet m2 destined to be cathodically polarized in the electrolyte solution flowing in the respective cell compartment may be of titanium, titanium-palladium or titanium nickel alloy, stainless steel, Hastelloy or other acid resistant metal, having a relatively high hydrogen ion discharge overvoltage or provided for this purpose with a surface coating layer of a high hydrogen overvoltage metal, preferably lead or lead-antimony alloy.

The bonding between the two metal sheets m1 and m2 may be established by any appropriate manner that shall ensure a good electrical contact. Conductive adhesive may be used or alternatively the two sheets of different metals may be soldered together by pressing them together with interposition of a low melting point solder, or even by spot welding the two sheets together.

The laminated metal septum has through holes for the constitution of inner inlet and outlet manifolds for the two distinct electrolyte solutions to be flown in the respective electrode compartments of each cell. As disclosed in said prior PCT patent application, insulating plastic grommets are introduced in the through holes of the laminated metallic core of the intercell bipolar interconnect I″ and the perimetral portions around the active electrode area, over both sides of the interconnect, are rendered electrically insulating by laminating thereon electrically insulating masks msk, for example of a thermoplastic insulating material resistant to the acid electrolytes, that will fuse with the plastic grommets inserted in the through holes to electrically shield planar perimeter surfaces over both sides of the interconnect as well as the surfaces of the circulation holes.

As disclosed in the cited prior PCT patent application of the same applicant, these masked perimeter areas of over both sides of the interconnect will coordinately bear against bas-relief patterned areas of the two elastomer gaskets assembled back-to-back that held there between perimeter portions of the permionic membrane M, thus defining distinct circulation paths and distribution channels in the respective compartments that allow to circulate the two electrolyte solutions in the respective compartments of all the cells of the bipolar stack.

The tridimensional view permits the observation of all the electrodes ma that will be anodically polarized in the electrolyte solution flowing though the respective compartment. Electrodes in contact with the unmasked conductive central area of the sheet m1 of the laminated structure may be in form of a pack of three micro nets of titanium or tantalum, coated with a catalytic layer containing a noble metal (Pt, Ir, Ru, Pd) and/or oxides, sub-oxides or mixed oxides of at least a noble metal, for providing a large active surface of the porous metallic electrode structure, wetted by the flowing electrolyte solution permeating the pack of micro nets, in flowing through the electrode containing compartment, from an inlet port at one corner to exit an outlet port at the diagonally opposite corner of the flow compartment.

A similar stacked micro net pack or a porous wire pad of a high hydrogen overvoltage metal such as lead, lead antimony alloy is used on the other side (not visible in the figure) of the bipolar intercell interconnects, destined to be cathodically polarized in the electrolyte solution flowing in the respective cell compartment, and on the other side (not visible) of the end interconnect I′ associated to the header h2.

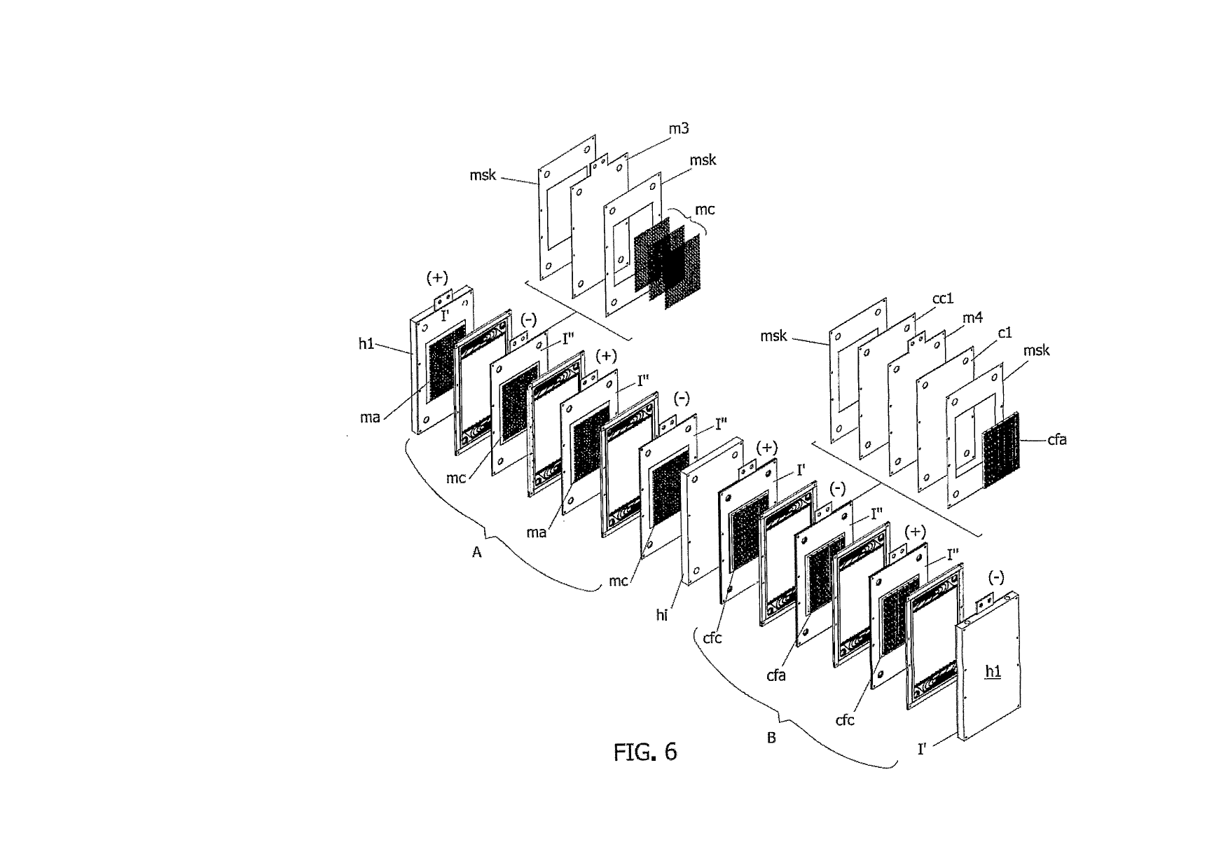

FIG. 6 is a tridimensional exploded view of two groups, A and B, of monopolar cells of a unified stack assembly according to a general arrangement of a multigroup stack of monopolar cells, as exemplified in FIG. 4, according to which the cells of the first group A are used exclusively for charging the redox flow battery system and the cells of the other group B are used exclusively for supplying electrical loads by discharging the redox flow battery system.

According to this alternative embodiment, different laminated structures of interconnect may be used for the cells of the group A (charge cells) and for the cells of the group B (discharge cells). taking into account the fact that the monopolar stack organization requires that every interconnect I″ and I′, must have a cross sectional area (cross section of lateral conduction) dimensioned to ensure negligeable resistance (voltge drop) in order to provide a good equipotentiality and uniformity of current distribution over the whole projected area of the cell electrodes ma-mc and cfa-cfc in contact therewith, respectively.

In case of “all-metallic” charge cells (group A) and “all-carbon” discharge cells (group B) the interconnects of the “all-metallic” charge cells (group A) may have a single metallic sheet core m3 of an acid resistant metal or alloy, adaptet to contact porous metallic anodes ma of porous metallic catodes mc over both sides and the interconnects of the “all-carbon” discharge cells (group B), adapted to contact carbon felt anodes cfa and carbon felt cathodes cfc over both sides, may be a laminated plate comprising a core sheet m4 of highly conductive metal, for example stainless steel, titanium, Hastelloy, or even aluminum or copper, sandwiched between two sheets cl both of a conductive carbon-resin aggregate, bonded onto the metallic core by hot pressing or any other effective manner. The carbon lelt electrodes may be spot bonded to the carbon aggregate sheets using a conductive adhesive.

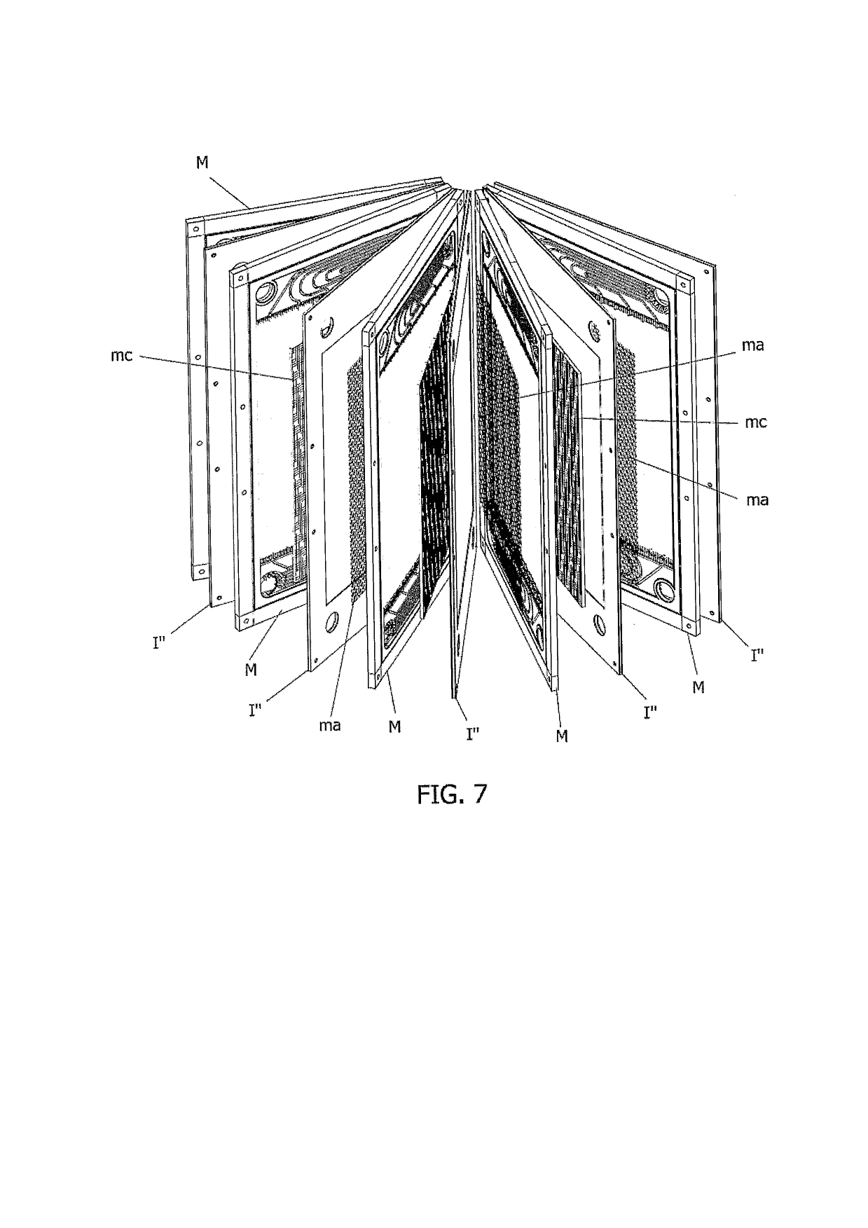

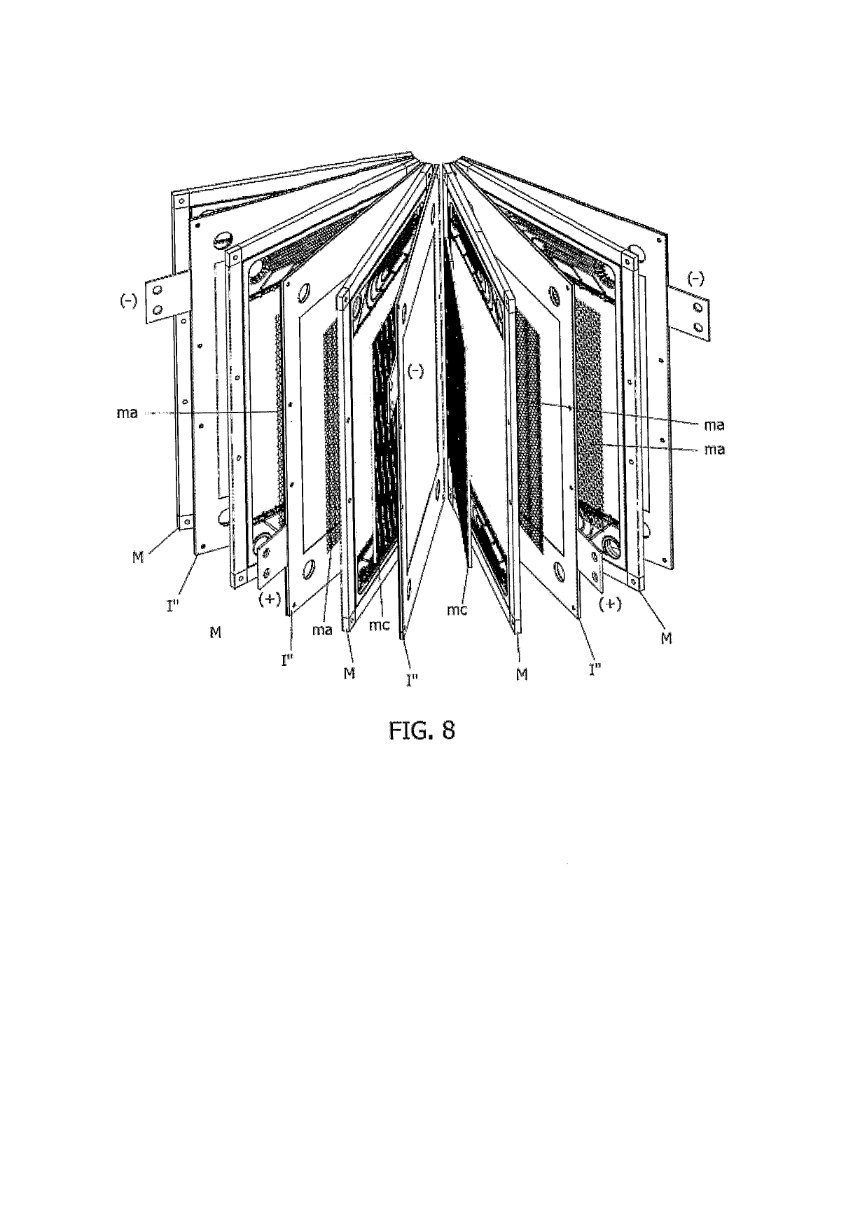

FIG. 7 is a “book-like” exploded view of stackable elements that define a bipolar charge cells and FIG. 8 is a “book-like” exploded view of stackable elements that define monopolar discharge cells.

The same reference numerical/literal identifiers that have been used in the preceding figures are used also in the two book like views thus allowing to observe, besides the organization of essential parts of the multicell stacks of this disclosure, also both types of porous electrodes: namely the electrodes that are exclusively polarized as anodes in the respective electrolyte solutions, ma or cfa, and the electrodes that are exclusively polarized as cathodes in the respective electrolyte solutions, mc or cfc.

Details of the membrane assemblies M and of the perimetral spacers 9 associated to them, as well as of the pairs of “bas-relief” patterned elastomer gaskets, back-to-back assembled for sandwiching there between the permionic membrane, of the shown embodiments are amply provided by the cited prior PCT patent application No. PCT/IB2010/001651, of the same applicant, the relevant content of which is here incorporated by express reference.

1. A redox flow battery system for energy storage comprising cells defined by a stacked, repetitive arrangement of a conductive inter-cell interconnect, a positive electrode, a perm-ionic membrane cell separator, a negative electrode and another conductive inter-cell interconnect, said electrodes being confined in respective flow compartments of two adjacent cells, the flow compartment of electrodes of opposite sign of each cells being hydraulically separated by said membrane, at least a first storage tank for a positively chargeable electrolyte solution, at least a second storage tank for a negatively chargeable electrolyte solution, distinct ducting and pumping means for circulating said electrolyte solutions from said storage tanks, through the respective flow compartment of the cells, wherein the system comprises distinct pluralities of cells defined by a stacked, repetitive arrangement of parts, each cell of a first plurality having flow compartments through which the respective electrolyte solutions flow for charging the battery system and each cell of a second plurality having flow compartments through which the respective electrolyte solutions flow when discharging the battery system to deliver DC power to electrical loads.

2. The redox flow battery system of claim 1, wherein the conductive inter-cell interconnect, the positive electrode and the negative electrode of all the cells of the first plurality are of metallic material; and the conductive inter-cell interconnect, the positive electrode and the negative electrode of all the cells of the second plurality are of carbonaceous substance or aggregate.

3. The redox flow battery system of claim 2, wherein said carbonaceous material or aggregate belongs to the group composed of carbon, graphite, glassy carbon, electrically conductive aggregates of carbon particles, graphite particles, glassy carbon particles, carbon black and mixtures thereof with a resin binder.

4. The redox flow battery system of claim 1, wherein the positive electrode of all the cells of the second plurality is of compressible porous carbon felt, the negative electrode has a porous metallic base belonging to the group composed of titanium, tantalum, zirconium and alloys thereof, coated with a layer containing a noble metal or a noble metal oxide or mixed oxides of a noble metal and at least of the base metal.

5. The redox flow battery system of claim 4, wherein the conductive inter-cell interconnect of all the cells of the second plurality comprises either a titanium plate or a titanium plate laminated to or having a facing of carbonaceous substance in electrical contact with the positive electrode of compressible porous carbon felt.

6. The redox flow battery system of claim 4, wherein the perm-ionic membranes have, over the surface in contact with the positively charged electrolyte solution, a porous electro-catalytic facing layer of particles of an acid resistant and anodically stable metal black, bonded to the perm-ionic membrane with a polytetrafluoroethylene and contacted at points by said negative electrode of porous metallic base.

7. The redox flow battery system of claim 1, wherein the positive electrode of all the cells of the first plurality has a metallic base belonging to the group composed of titanium, tantalum, zirconium and alloys thereof, coated with a layer containing a noble metal or a noble metal oxide or mixed oxides of a noble metal and at least of the base metal, and the negative electrode has a metallic base belonging to the group composed of stainless steel, titanium-palladium alloy, titanium-nickel alloy, lead, lead alloys, antimony, antimony alloys, all resistant to the respective acid aqueous electrolyte solution.

8. The redox flow battery system of claim 1, wherein the positive and negative electrodes of said first plurality have a smaller projected area than the electrodes of the second plurality.

9. The redox flow battery system of claim 1, wherein the number of cells of said first plurality is smaller than the number of cells of said second plurality.

10. The redox flow battery system of claim 1, wherein the flow rates of the two electrolyte solutions through the cells of said first phase and through the cells of said second plurality are regulated independently from one another.

11. The redox flow battery system of claim 2, wherein the positive electrode of all the cells of the second plurality is of compressible porous carbon felt, the negative electrode has a porous metallic base belonging to the group composed of titanium, tantalum, zirconium and alloys thereof, coated with a layer containing a noble metal or a noble metal oxide or mixed oxides of a noble metal and at least of the base metal.

12. The redox flow battery system of claim 11, wherein the conductive inter-cell interconnect of all the cells of the second plurality comprises either a titanium plate or a titanium plate laminated to or having a facing of carbonaceous substance in electrical contact with the positive electrode of compressible porous carbon felt.

13. The redox flow battery system of claim 11, wherein the perm-ionic membranes have, over the surface in contact with the positively charged electrolyte solution, a porous electro-catalytic facing layer of particles of an acid resistant and anodically stable metal black, bonded to the perm-ionic membrane with a polytetrafluoroethylene and contacted at points by said negative electrode of porous metallic base.

14. The redox flow battery system of claim 2, wherein the positive electrode of all the cells of the first plurality has a metallic base belonging to the group composed of titanium, tantalum, zirconium and alloys thereof, coated with a layer containing a noble metal or a noble metal oxide or mixed oxides of a noble metal and at least of the base metal, and the negative electrode has a metallic base belonging to the group composed of stainless steel, titanium-palladium alloy, titanium-nickel alloy, lead, lead alloys, antimony, antimony alloys, all resistant to the respective acid aqueous electrolyte solution.
